(19) United States
(12) Patent Application Publication
(10) Pub. No.: US 2025/0304186 A1
(43) Pub. Date: Oct. 2, 2025

(54) VEHICLE FRONT STRUCTURE

(71) Applicant: TOYOTA JIDOSHA KABUSHIKI KAISHA, Aichi-ken (JP)

(72) Inventor: Koji SAEKI, Okazaki-shi (JP)

(21) Appl. No.: 19/066,161

(22) Filed: Feb. 28, 2025

(30) Foreign Application Priority Data
Apr. 1, 2024 (JP) 2024-059052

(51) Int. Cl. B62D 25/14; B60H 1/00

(52) U.S. Cl. CPC B62D 25/142; B60H 1/00521

(57) ABSTRACT

A vehicle front structure includes a dash module that separates an inside and an outside of a vehicle cabin from each other, the dash module having a channel for a cooling refrigerant extending in the vehicle-width direction, and at least one heat generating device disposed in contact with or close to the dash module.

### CROSS-REFERENCE TO RELATED APPLICATION

This application claims priority to Japanese Patent Application No. 2024-059052 filed on Apr. 1, 2024, incorporated herein by reference in its entirety.

### BACKGROUND

### 1. Technical Field

The disclosure relates to a vehicle front structure.

### 2. Description of Related Art

Japanese Unexamined Patent Application Publication No. 2008-207616 discloses a gasoline-powered vehicle including an auxiliary battery disposed adjacent to a dash panel.

### SUMMARY

In a battery electric vehicle, since a grille opening is narrower than that of a gasoline-powered vehicle, air may stay inside a power unit compartment in which a power unit as a driving source is disposed. Thus, when an auxiliary battery and an integrated electronic control unit (hereinbelow, referred to as ECU) that are disposed near a dash panel generate heat, discharge of heat may become insufficient, which may cause deterioration of functionality.

The present disclosure provides a vehicle front structure that can cool a heat generating device using a dash module.

A vehicle front structure according to a first aspect includes a dash module that separates an inside and an outside of a vehicle cabin from each other, the dash module having a channel for a cooling refrigerant extending in a vehicle-width direction, and at least one heat generating device disposed in contact with or close to the dash module.

In the vehicle front structure according to the first aspect, the dash module has the channel for the cooling refrigerant extending in the vehicle-width direction, and the at least one heat generating device is disposed in contact with or close to the dash module having the channel for the cooling refrigerant. Thus, since the cooling refrigerant flowing through the channel cools the dash module, the at least one heat generating device disposed in contact with or close to the dash module can be cooled.

The at least one heat generating device may be directly mounted on the dash module.

In the vehicle front structure, since the at least one heat generating device is directly mounted on the dash module, the at least one heat generating device can be efficiently cooled by the dash module.

The dash module may be mounted on a frame member of a vehicle.

In the vehicle front structure, since the dash module is mounted on the frame member of the vehicle, the dash module and the frame member of the vehicle are separate bodies. The dash module separate from the frame member of the vehicle enables the dash module to have a closed section. Thus, the channel can be formed inside the dash module.

The dash module may include a dash panel having a plate shape, and the channel may be provided inside the dash panel.

In the vehicle front structure, since the channel is provided inside the dash panel having a plate shape, the cooling refrigerant flowing inside the dash panel cools the dash module. Accordingly, the at least one heat generating device can be cooled by disposing the at least one heat generating device in contact with the dash module or close to the dash module.

The dash module may include a dash panel having a plate shape, and a plate member fixed to the dash panel. The channel may be defined by the plate member and the dash panel.

In the vehicle front structure, since the plate member and the dash panel having a plate shape define the channel, the at least one heat generating device can be cooled by disposing the at least one heat generating device in contact with or close to at least one of the plate member and the dash panel.

The dash module may include a dash panel having a plate shape, and a plate member fixed to the dash panel. The channel may be provided in the plate member.

In the vehicle front structure, since the channel is formed in the plate member fixed to the dash panel, the cooling refrigerant flowing through the channel formed in the plate member cools the dash module. Accordingly, the at least one heat generating device can be cooled by mounting the at least one heat generating device in contact with the dash module or close to the dash module.

At least a part of the channel may be disposed facing the at least one heat generating device in a vehicle front-rear direction.

In the vehicle front structure, since at least a part of the channel is disposed facing the at least one heat generating device in the vehicle front-rear direction, the at least one heat generating device can be efficiently cooled.

The at least one heat generating device may include a first heat generating device, and a second heat generating device mounted on the dash module such that the second heat generating device and the first heat generating device face each other with the dash module interposed between the second heat generating device and the first heat generating device.

In the vehicle front structure, since the second heat generating device is mounted on the dash module such that the second heat generating device and the first heat generating device face each other with the dash module interposed therebetween, the first heat generating device and the second heat generating device can be disposed facing each other with the channel interposed therebetween. Accordingly, the first heat generating device and the second heat generating device can be efficiently cooled.

The channel may extend at least in the vehicle-width direction and include a plurality of channels provided in a vehicle-height direction. The dash module may have a projection projecting in the vehicle front-rear direction in a portion corresponding to each of the channels. The projection may have a flat tip face.

In the vehicle front structure, the dash module has the projection projecting in the vehicle front-rear direction in the portion corresponding to each of the channels, and the projection has the flat tip face. Thus, compared to a case in which the tip face is formed in, for example, a spherical shape, it is possible to increase the surface area corresponding to the at least one heat generating device and improve cooling capacity.

The channel may have an inflow port and an outflow port, the inflow port and the outflow port being provided on one side in the vehicle-width direction.

In the vehicle front structure, since the inflow port and the outflow port of the channel are provided on one side in the vehicle-width direction, a refrigerant path in the vehicle can be simplified.

The at least one heat generating device may be an auxiliary battery or an integrated control unit.

In the vehicle front structure, since the at least one heat generating device is the auxiliary battery or the integrated control unit, the auxiliary battery or the integrated control unit can be cooled.

The first heat generating device may be an auxiliary battery, and the second heat generating device may be an integrated control unit.

In the vehicle front structure, since the first heat generating device is the auxiliary battery and the second heat generating device is the integrated control unit, the auxiliary battery and the integrated control unit can be efficiently cooled.

As described above, the vehicle front structure according to the present disclosure can cool the heat generating device using the dash module.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically showing an example of a vehicle front structure according to a first embodiment of the present disclosure;

FIG. 2 is a left side view schematically showing an example of the vehicle front structure of FIG. 1;

FIG. 3 is an enlarged sectional view of a dash module in the vehicle front structure of FIG. 2;

FIG. 4 is a sectional view taken along line IV-IV of FIG. 3;

FIG. 5 is a sectional view showing a modification of the dash module of FIG. 4;

FIG. 6 is a left side sectional view schematically showing an example of a dash module of a vehicle front structure according to a second embodiment of the present disclosure;

FIG. 7 is a sectional view taken along line IIV-IIV of FIG. 6;

FIG. 8 is a sectional view showing a modification of the dash module of FIG. 7;

FIG. 9 is a left side sectional view schematically showing an example of a dash module of a vehicle front structure according to a third embodiment of the present disclosure;

FIG. 10 is a left side sectional view schematically showing an example of a dash module of a vehicle front structure according to a fourth embodiment of the present disclosure; and

FIG. 11 is a left side sectional view schematically showing an example of a dash module of a vehicle front structure according to a fifth embodiment of the present disclosure.

### DETAILED DESCRIPTION OF EMBODIMENTS

### First Embodiment

Hereinbelow, a vehicle front structure according to a first embodiment of the present disclosure will be described with reference to the accompanying drawings. Note that, in the present specification and the drawings, constituent elements having substantially the same functional configuration are designated by the same reference sign to omit redundant description. In addition, arrow FR shown as appropriate in each drawing indicates the front side in the vehicle front-rear direction, and arrow UP indicates the upper side in the vehicle-height direction. Arrow RH indicates the right side in the vehicle-width direction. Hereinbelow, when description is made simply using front and rear, up and down, and right and left, it means front and rear in the vehicle front-rear direction, up and down in the vehicle-height direction, and right and left in the vehicle right-left direction (vehicle-width direction) unless otherwise specifically noted.

### Configuration of Vehicle Front Structure

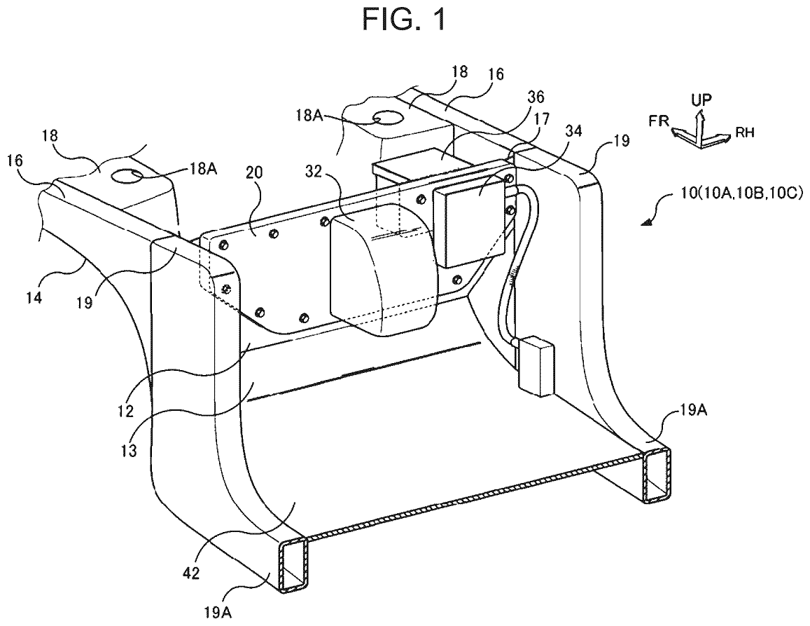

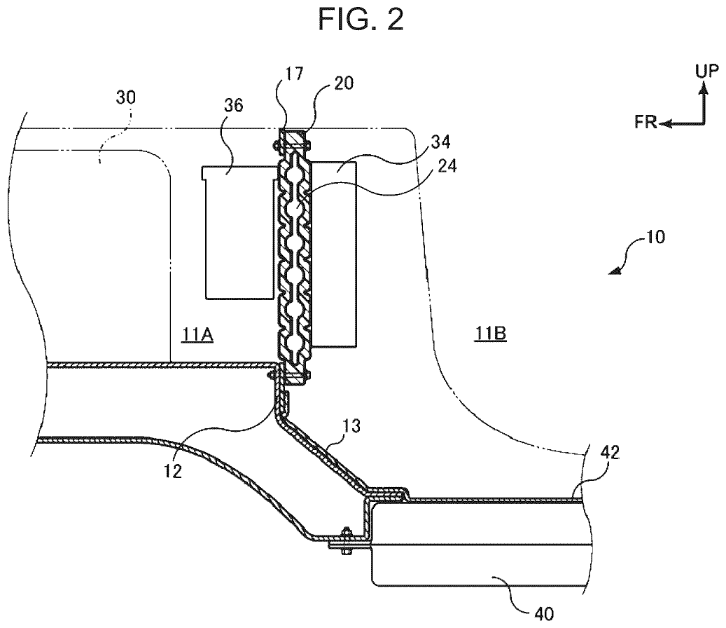

First, the configuration of a vehicle front structure 10 will be described as an example of the vehicle front structure according to the first embodiment of the present disclosure. FIG. 1 is a perspective view schematically showing an example of the vehicle front structure 10, and FIG. 2 is a left side view schematically showing an example of the vehicle front structure 10 of FIG. 1.

FIGS. 1 and 2 schematically show the vehicle front structure 10 having a structure including a frame of a front portion of a vehicle. In the present embodiment, examples of the vehicle include a battery electric vehicle (BEV), a fuel cell electric vehicle (FCEV), a hybrid electric vehicle (HEV), and a plug-in hybrid electric vehicle (PHEV) that travel using power generated by a power unit.

The vehicle front structure 10 includes a pair of right and left front side members (not shown). The right and left front side members are front frame members of the vehicle, and disposed on the right side and the left side of the front portion of the vehicle in the vehicle-width direction, respectively. The front side members extend in the vehicle front-rear direction, and a rear end portion of each of the front side members in the vehicle front-rear direction is connected to a cross member 12 shown in FIG. 1. Wheel wells 14 in each of which a tire as a tire-wheel assembly (not shown) is disposed are provided outside the front side members in the vehicle-width direction, and the right and left wheel wells 14 are connected by the cross member 12.

Apron upper members 16 are disposed rearward of the right and left front side members. One of the apron upper members 16 is disposed outside the right front side member in the vehicle-width direction and above the right front side member in the vehicle-height direction. The other one of the apron upper members 16 is disposed outside the left front side member in the vehicle-width direction and above the left front side member in the vehicle-height direction. Each of the apron upper members 16 is a frame member that constitutes an upper side frame in the vehicle front structure 10 and extends in the vehicle front-rear direction along the corresponding front side member. The front side members and the apron upper members 16 have a substantially rectangular open cross-sectional shape provided with an opening on the outer side in the vehicle-width direction, in other words, a substantially rectangular cross-sectional shape open on the outer side in the vehicle-width direction. The opening in each apron upper member 16 is not illustrated in the drawings.

A pair of right and left fender aprons 17 are disposed inside the apron upper members 16 in the vehicle-width direction. Each of the fender aprons 17 has an upper end joined to the apron upper member 16 and a lower end joined to the front side member, and a suspension tower 18 and the wheel well 14 are integrally formed with the fender apron 17. The suspension tower 18 is provided outside the front side member in the vehicle-width direction and above the front side member in the vehicle-height direction. An upper end face of the suspension tower 18 is provided with a through-hole 18A in which an upper end of a suspension (not shown) is disposed.

A dash module 20 is disposed between the right and left apron upper members 16. As shown in FIG. 2, the dash module 20 is a member that separates a power unit compartment 11A that is a space in which a power unit 30 is housed outside a vehicle cabin 11B and the vehicle cabin 11B from each other. As shown in FIGS. 1 and 2, the dash module 20 extends in the vehicle-width direction and the vehicle-height direction with its thickness direction aligned with the vehicle front-rear direction. The dash module 20 has vehicle-width direction end portions connected to the fender aprons 17 and a lower end portion connected to the cross member 12. Although, in the present embodiment, the dash module 20 is a plate-shaped member having a size corresponding to a panel for separating the power unit compartment 11A and the vehicle cabin 11B from each other, the present disclosure is not limited this mode.

An air conditioning unit 32 that is an air conditioner is mounted on a rear face of the dash module 20 in the vehicle front-rear direction at a substantially central portion in the vehicle-width direction of the rear face, and an integrated control unit (hereinbelow, referred to as the integrated ECU) 34 is mounted at a right portion of the rear face of the dash module 20. In addition, an auxiliary battery 36 is mounted on a front face of the dash module 20 in the vehicle front-rear direction at a right portion of the front face.

The air conditioning unit 32 adjusts the temperature, the humidity, and the like in the vehicle cabin 11B. The integrated ECU 34 integrally controls the entire vehicle systems and functions that are made complicated to control many devices and functions. The auxiliary battery 36 is a battery that is used in an auxiliary manner when electric power of a battery (not shown) is insufficient, and an uninterruptible power supply (UPS) is used, for example. In the present embodiment, the integrated ECU 34 and the auxiliary battery 36 are heat generating devices, and the auxiliary battery 36 corresponds to the second heat generating device of the present disclosure. The structure of the dash module 20 will be described in detail further below.

The cross member 12 is joined at its lower end to a dash panel lower 13.

The dash panel lower 13 extends in the vehicle-width direction along the dash module 20. The dash panel lower 13 functions as a so-called toe board on which the feet of an occupant seated on a front seat are placed. Although not shown, a brake pedal, an accelerator pedal, and the like are disposed on the dash panel lower 13.

Front pillars 19 extending in the vehicle-height direction are joined to the rear side of each of the fender aprons 17 in the vehicle front-rear direction. Rear end portions 19A of the front pillars 19 on the lower side in the vehicle-height direction extend in the vehicle front-rear direction and are connected to rockers (not shown) that constitute a frame of side portions of a vehicle body.

A floor panel 42 that constitutes a floor of the vehicle is disposed between the pair of right and left rockers. The floor panel 42 is connected to a rear end portion of the dash panel lower 13 and, for example, constitutes the floor of the vehicle together with the dash panel lower 13. In addition, as shown in FIG. 2, in the vehicle cabin 11B, a battery unit 40 is disposed under the floor panel 42. As an example, the battery unit 40 includes a case having a housing shape, and a plurality of battery cells (cells) disposed inside the case. The battery cell is, for example, a lithium-ion secondary battery, a nickel-metal hydride secondary battery, or an all-solid-state battery.

As an example, the vehicle front structure 10 of the present embodiment includes the pair of front side members (not shown), the cross member 12, the wheel wells 14, the apron upper members 16, the fender aprons 17, and the suspension towers 18 that are integrally molded by aluminum die casting.

### Configuration of Dash Module

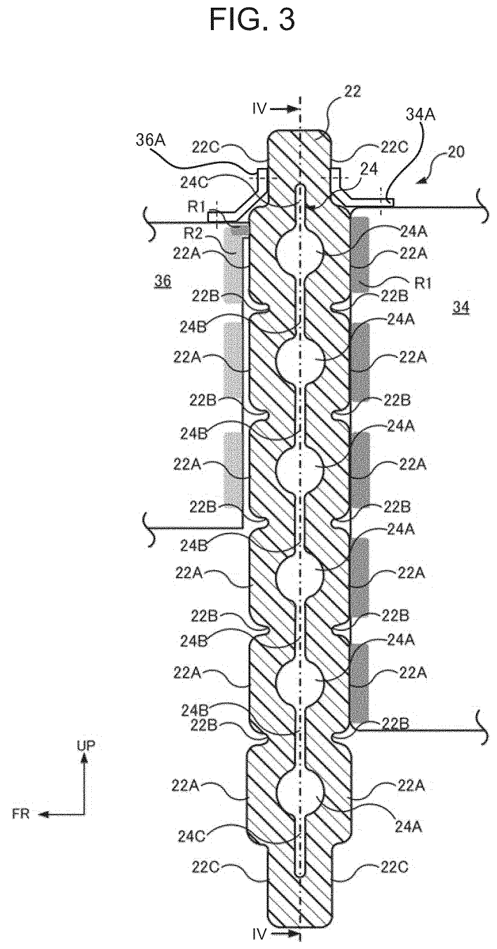

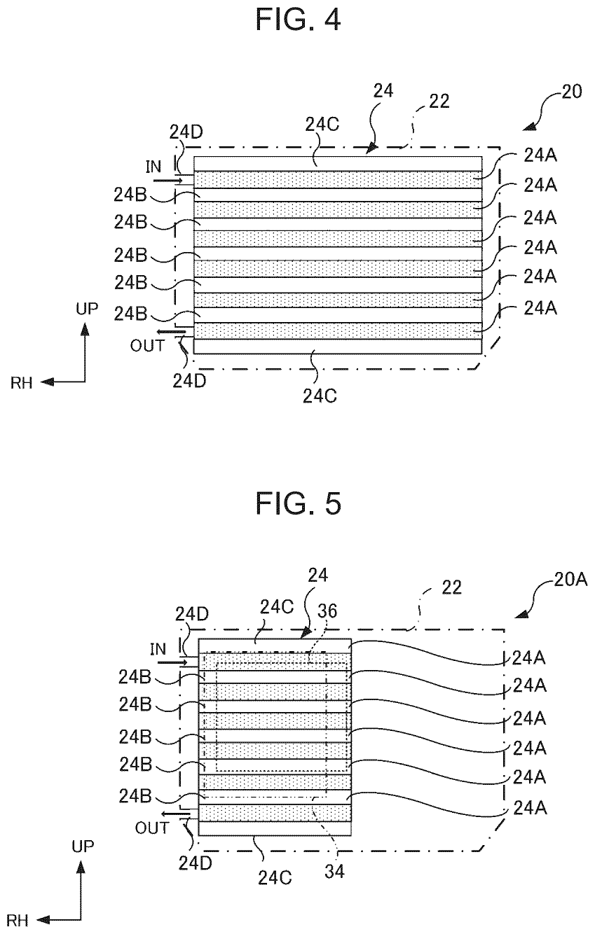

Next, the configuration of the dash module 20 will be described. FIG. 3 is an enlarged sectional view of the dash module 20 in the vehicle front structure 10 of FIG. 2, and FIG. 4 is a sectional view taken along line IV-IV of FIG. 3. The dash module 20 of the present embodiment has a cooling function. As shown in FIG. 3, the dash module 20 includes, for example, a dash panel 22, and an internal space 24 formed inside the dash panel 22. In the present embodiment, the internal space 24 functions as a channel through which a cooling refrigerant flows, and the cooling function is provided by the cooling refrigerant flowing through the internal space 24.

The dash panel 22 includes, in the vehicle-height direction, a plurality of projections 22A (six projections 22A in the present embodiment) projecting in the vehicle front-rear direction, and each of the projections 22A has a flat tip. The dash panel 22 also includes recesses 22B recessed in the vehicle front-rear direction between the projections 22A adjacent to each other in the vehicle-height direction. The projections 22A and the recesses 22B extend in the vehicle-width direction. The projections 22A are formed at positions opposed to each other on both side faces in the vehicle front-rear direction, and the recesses 22B are formed at positions opposed to each other on both the side faces in the vehicle front-rear direction.

As shown in FIGS. 3 and 4, the internal space 24 serving as the channel includes, in the vehicle-height direction, a plurality of main passages 24A, each of the main passages 24A having a substantially circular cross-sectional shape in side view, and a plurality of communication passages 24B that provides communication between the main passages 24A adjacent to each other in the vehicle-height direction. As an example, the internal space 24 of the present embodiment includes six main passages 24A, and five communication passages 24B. As shown in FIG. 3, each of the main passages 24A is disposed at a position corresponding to the projection 22A. In addition, as an example, the internal space 24 includes endmost passages 24C communicating with the main passages 24A on both ends in the vehicle-height direction.

As shown in FIG. 4, the main passages 24A, the communication passages 24B, and the endmost passages 24C extend in the vehicle-width direction. In FIG. 4, for convenience sake, the main passages 24A are shown with hatching. In the present embodiment, as an example, each of the uppermost and lowermost main passages 24A in the vehicle-height direction is provided with, on the right side in the vehicle-width direction, an inflow-outflow passage 24D that communicates with the outside of the dash panel 22 and through which the cooling refrigerant flows in or out. In the present embodiment, as an example, the upper inflow-outflow passage 24D is used as an inflow port, and the lower inflow-outflow passage 24D is used as an outflow port. As an example, each of the upper and lower inflow-outflow passages 24D is connected to a pipe (not shown) through which the cooling refrigerant flows inside the power unit compartment 11A. Examples of the pipe connected with each of the upper and lower inflow-outflow passages 24D include pipes used in the power unit 30 and the air conditioning unit 32, and a pipe used to cool the battery unit 40.

As an example, the dash panel 22 having the above structure is formed of resin, specifically, formed of a thermoplastic elastomer. In the present embodiment, as an example, the dash panel 22 is formed by injection molding.

The air conditioning unit 32, the integrated ECU 34, and the auxiliary battery 36 described above are mounted on the dash module 20 configured as described above. As shown in FIG. 3, as an example, the integrated ECU 34 is mounted at its upper end portion on the rear face of the dash module 20 with a bracket 34A having a section formed in a substantially L-shape. Similarly, as an example, the auxiliary battery 36 is also mounted at its upper end portion on the front face of the dash module 20 with a bracket 36A having a section formed in a substantially L-shape. Although not shown, the air conditioning unit 32 is also mounted on the dash module 20 with a bracket in a similar manner.

### Actions and Effects of First Embodiment

Next, the actions and effects of the first embodiment will be described.

In the vehicle front structure 10 of the first embodiment, the dash module 20 has the internal space 24 as the channel for the cooling refrigerant, and the integrated ECU 34 and the auxiliary battery 36 as the heat generating devices are mounted in contact with the dash module 20 having the internal space 24. Thus, when the cooling refrigerant flows in through the upper inflow-outflow passage 24D of the dash module 20 and flows through the internal space 24, the cooling refrigerant flowing through the internal space 24 cools the dash module 20. Thus, the heat generating devices mounted in contact with the dash module 20 can be cooled.

In addition, in the vehicle front structure 10 of the first embodiment, since the integrated ECU 34 and the auxiliary battery 36 as the heat generating devices are directly mounted on the dash module 20, the heat generating devices can be efficiently cooled by the dash module 20.

In addition, in the vehicle front structure 10 of the first embodiment, since the channel is provided inside the dash panel 22 constituting the dash module 20, the cooling refrigerant flowing inside the dash panel 22 cools the dash module 20. Accordingly, the heat generating devices can be cooled by mounting the heat generating devices in contact with the dash module 20 or close to the dash module 20. In the technique of the present disclosure, “being close” is intended to indicate a range X within which heat propagation can occur, and the range X is preferably, for example, 0<X≤10 mm.

In addition, in the vehicle front structure 10 of the first embodiment, each of the projections 22A of the dash module 20 projecting in the vehicle front-rear direction in the portion corresponding to the main passage 24A has the flat tip face. Thus, compared to a case in which the tip face is formed in, for example, a spherical shape, it is possible to increase the surface area corresponding to the heat generating devices and improve cooling capacity. In the first embodiment, for example, as shown in FIG. 3, the integrated ECU 34 is mounted in contact with the dash panel 22. Thus, a region R1 indicated by shading that is a portion in contact with the tip face of the projection 22A is more efficiently cooled. In addition, as an example, the auxiliary battery 36 has an outer peripheral face projecting more at its upper end than at the other part. Thus, in the auxiliary battery 36, the region R1 indicated by the shading at the upper end portion is a portion in contact with the tip face of the projection 22A, and a region R2 indicated by shading lighter than the shading of the region R1 is a portion close to the tip face of the projection 22A. Thus, the auxiliary battery 36 is cooled more efficiently in the region R1 than in the region R2. The shape of the auxiliary battery 36 is not limited to the shape described above, and the outer peripheral face on the rear side may be flat in the vehicle-height direction. In this case, since the outer peripheral face of the auxiliary battery 36 on the rear side can be kept in contact with the dash panel 22, the auxiliary battery 36 can be more efficiently cooled.

In addition, in the vehicle front structure 10 of the first embodiment, since the auxiliary battery 36 is mounted on the dash module 20 such that the auxiliary battery 36 and the integrated ECU 34 face each other with the dash module 20 interposed therebetween, the integrated ECU 34 and the auxiliary battery 36 can be disposed facing each other with the internal space 24 serving as the channel interposed therebetween. This enables the integrated ECU 34 and the auxiliary battery 36 to be cooled by the internal space 24 in a range overlapping the auxiliary battery 36 and the integrated ECU 34 when viewed in the vehicle front-rear direction. Thus, the integrated ECU 34 and the auxiliary battery 36 can be more efficiently cooled.

In addition, in the vehicle front structure 10 of the first embodiment, since the inflow-outflow passages 24D serving as the inflow port and the outflow port of the internal space 24 are provided on one side in the vehicle-width direction (the right side in the present embodiment), a refrigerant path in the vehicle equipped with the vehicle front structure 10 can be simplified. The inflow-outflow passages 24D on both ends in the vehicle-height direction may be provided not on the right side but on the left side, or one of the inflow-outflow passages 24D may be provided on the right side and the other one of the inflow-outflow passages 24D may be provided on the left side. The arrangement of the inflow-outflow passages 24D can be changed as appropriate in accordance with the refrigerant path of the vehicle.

In addition, in the vehicle front structure 10 of the first embodiment, since the integrated ECU 34 and the auxiliary battery 36 are mounted as the heat generating devices on the dash module 20, the dash module 20 can cool the integrated ECU 34 and the auxiliary battery 36. The heat generating device mounted on the dash module 20 is not limited to the above, and another heat generating device may be mounted, or only the integrated ECU 34 or the auxiliary battery 36 may be mounted. In addition to the above, another heat generating device may further be mounted.

In addition, in the vehicle front structure 10 of the first embodiment, since the integrated ECU 34 and the auxiliary battery 36 are disposed facing each other with the internal space 24 serving as the channel interposed therebetween, the integrated ECU 34 and the auxiliary battery 36 can be efficiently cooled.

In addition, in the vehicle front structure 10 of the first embodiment, since the dash module 20 is mounted on the frame member of the vehicle integrally molded by die casting, the dash module 20 and the frame member of the vehicle are separate bodies. The dash module 20 separate from the frame member of the vehicle enables the dash module 20 to have a closed section. Thus, the internal space 24 serving as the channel can be formed inside the dash module 20.

### Modification of First Embodiment

Although, in the first embodiment, the internal space 24 is formed in substantially the entire dash module 20 in the vehicle-width direction as shown in FIG. 4, the present disclosure is not limited thereto. FIG. 5 is a sectional view showing a modification of the dash module 20 of FIG. 4. As shown in FIG. 5, an internal space 24 of a dash module 20A of the modification is provided in a range from a right end portion to a substantially central portion in the vehicle-width direction. Specifically, the internal space 24 is provided in a range overlapping both the integrated ECU 34 and the auxiliary battery 36 when viewed in the vehicle front-rear direction.

By providing the internal space 24 serving as the channel only in the range facing the integrated ECU 34 and the auxiliary battery 36, that is, the heat generating devices in the vehicle front-rear direction in this manner, the heat generating devices can be cooled with less cooling refrigerant than in the first embodiment. Thus, with the dash module 20A of the modification, the heat generating devices can be more efficiently cooled.

In addition, in the dash module 20A of the modification, the auxiliary battery 36 is mounted on the dash module 20A such that the auxiliary battery 36 and the integrated ECU 34 face each other with the dash module 20A interposed therebetween. Thus, the range of the internal space 24 overlapping the auxiliary battery 36 and the integrated ECU 34 when viewed in the vehicle front-rear direction can be reduced. Thus, the integrated ECU 34 and the auxiliary battery 36 can be more efficiently cooled.

### Second Embodiment

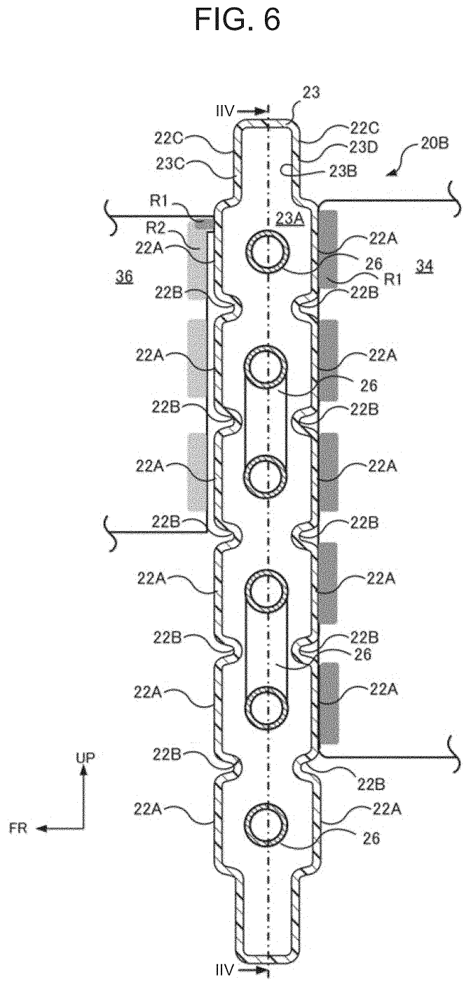

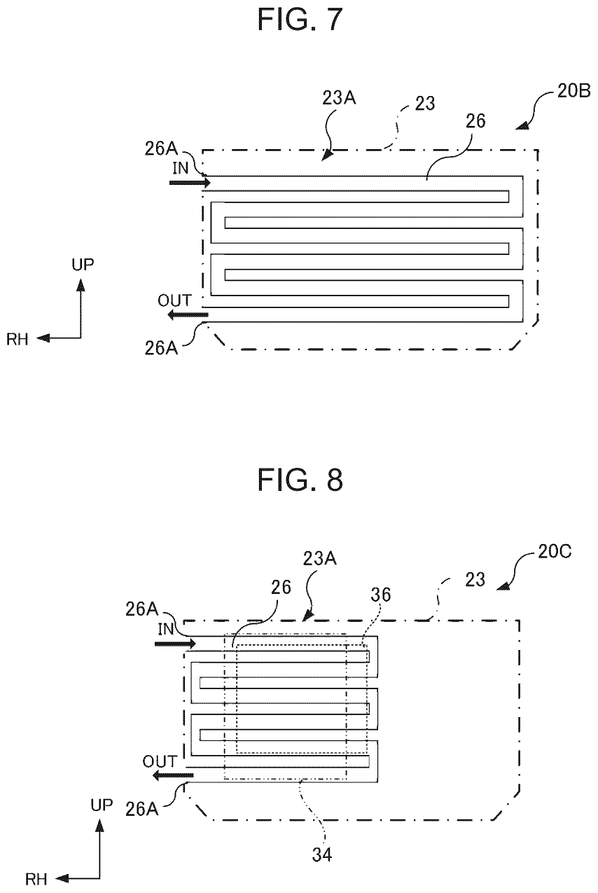

Next, a vehicle front structure 10A (refer to FIG. 1) according to a second embodiment of the present disclosure will be described. FIG. 6 is a left side sectional view schematically showing an example of a dash module 20B of the vehicle front structure 10A according to the second embodiment of the present disclosure, and FIG. 7 is a sectional view taken along line IIV-IIV of FIG. 6. In the dash module 20B of the second embodiment, configurations similar to those of the dash module 20 of the first embodiment described above are designated by the same reference signs to omit description thereof, and only differences will be described in detail.

The vehicle front structure 10A of the second embodiment includes the dash module 20B shown in FIG. 6. While the internal space 24 formed inside the dash panel 22 serves as the channel of the dash module 20 in the first embodiment described above, a refrigerant pipe 26 disposed inside a dash panel 23 serves as a channel of the dash module 20B of the second embodiment.

As shown in FIG. 6, as with the dash panel 22 of the first embodiment described above, the dash panel 23 includes six projections 22A in the vehicle-height direction, and each of the projections 22A has a flat tip. The dash panel 23 also includes recesses 22B between the projections 22A adjacent to each other in the vehicle-height direction. The projections 22A and the recesses 22B extend in the vehicle-width direction. The projections 22A are formed at positions opposed to each other on both side faces in the vehicle front-rear direction, and the recesses 22B are formed at positions opposed to each other on both the side faces in the vehicle front-rear direction.

As an example, the dash panel 23 has a substantially uniform thickness and has an internal space 23A. As an example, an inner wall 23B that defines the internal space 23A has a shape smaller than the outer shape of the dash panel 23 by the thickness of the dash panel 23. In the present embodiment, the refrigerant pipe 26 that is a pipe serving as the channel through which a cooling refrigerant flows in a circulating manner is disposed in the internal space 23A. In FIG. 6, since the refrigerant pipe 26 is schematically shown, the refrigerant pipe 26 is not in contact with the inner wall 23B of the internal space 23A corresponding to the projection 22A. However, in actuality, the refrigerant pipe 26 is disposed in contact with the inner wall 23B of the internal space 23A corresponding to the projection 22A and has a size that enables the refrigerant pipe 26 to be in contact with the inner wall 23B.

As shown in FIG. 7, the refrigerant pipe 26 extends in the vehicle-width direction and includes a plurality of pipes (six pipes in the present embodiment) disposed parallel to each other in the vehicle-height direction in a meandering manner. As an example, the refrigerant pipe 26 has a substantially cylindrical shape and made of metal and resin. In the present embodiment, as an example, the refrigerant pipe 26 has inflow-outflow passages 26A that are openings at both ends of the refrigerant pipes 26. One of the inflow-outflow passages 26A is disposed corresponding to the uppermost projection 22A on the right side of the internal space 23A in the vehicle-width direction, and the other one of the inflow-outflow passages 26A is disposed corresponding to the lowermost projection 22A on the right side of the internal space 23A in the vehicle-width direction. The inflow-outflow passages 26A of the refrigerant pipe 26 communicate with the outside of the dash panel 23, and the cooling refrigerant flows in or out through the inflow-outflow passages 26A. In the present embodiment, as an example, the upper inflow-outflow passage 26A is used as an inflow port, and the lower inflow-outflow passage 26A is used as an outflow port. As with the first embodiment described above, as an example, each of the upper and lower inflow-outflow passages 26A is connected to the pipe (not shown) through which the cooling refrigerant flows inside the power unit compartment 11A.

As an example, the dash panel 23 is divided at substantially the center in the vehicle front-rear direction, and includes two components, specifically, an outer panel 23C on the power unit compartment 11A side and an inner panel 23D on the vehicle cabin 11B side. After the refrigerant pipe 26 is attached to the internal space 23A of any one of the outer panel 23C and the inner panel 23D, the other panel is attached to form the dash module 20B with the refrigerant pipe 26 disposed in the internal space 23A.

### Actions and Effects of Second Embodiment

Next, the actions and effects of the second embodiment will be described.

In the vehicle front structure 10A of the second embodiment, the refrigerant pipe 26 serves as the channel provided inside the dash module 20B. Even when the refrigerant pipe 26 serves as the channel in this manner, effects similar to those of the first embodiment can be obtained.

### Modification of Second Embodiment

Although, in the dash module 20B of the second embodiment, as shown in FIG. 7, the refrigerant pipe 26 is disposed in substantially the entire internal space 23A in the vehicle-width direction, the present disclosure is not limited thereto. FIG. 8 is a sectional view showing a modification of the dash module 20B of FIG. 7. As shown in FIG. 8, a refrigerant pipe 26 of a dash module 20C of the modification is disposed in a range from a right end portion to a substantially central portion in the vehicle-width direction. Specifically, the refrigerant pipe 26 is provided in a range overlapping both the integrated ECU 34 and the auxiliary battery 36 when viewed in the vehicle front-rear direction.

By providing the refrigerant pipe 26 serving as the channel only in the range facing the integrated ECU 34 and the auxiliary battery 36, that is, the heat generating devices in the vehicle front-rear direction, the heat generating devices can be cooled with less cooling refrigerant than in the second embodiment. Thus, with the dash module 20C of the modification, the heat generating devices can be more efficiently cooled.

In addition, in the dash module 20C of the modification, the auxiliary battery 36 is mounted on the dash module 20C such that the auxiliary battery 36 and the integrated ECU 34 face each other with the dash module 20C interposed therebetween. Thus, the range of the internal space 23A overlapping the auxiliary battery 36 and the integrated ECU 34 when viewed in the vehicle front-rear direction can be reduced. Thus, the integrated ECU 34 and the auxiliary battery 36 can be more efficiently cooled.

### Third Embodiment

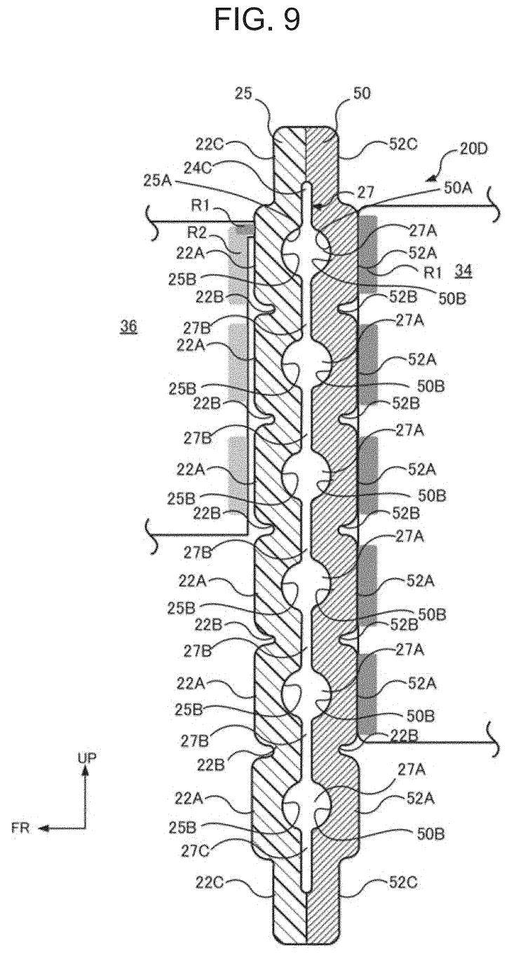

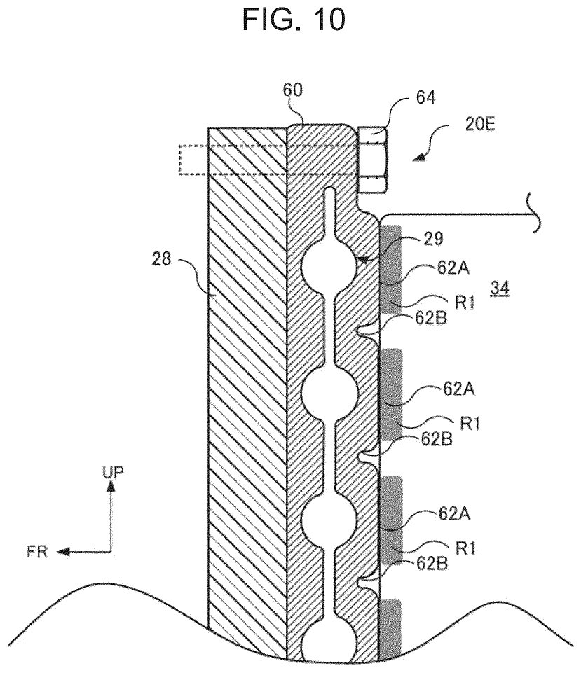

Next, a vehicle front structure 10B (refer to FIG. 1) according to a third embodiment of the present disclosure will be described. FIG. 9 is a left side sectional view schematically showing an example of a dash module 20D of the vehicle front structure 10B according to the third embodiment of the present disclosure. The vehicle front structure 10B of the third embodiment includes the dash module 20D shown in FIG. 9. The dash module 20D of the third embodiment includes a dash panel 25, and a plate member 50. In the dash panel 25 of the third embodiment, configurations similar to those of the dash panel 22 of the first embodiment described above are designated by the same reference signs to omit description thereof, and only differences will be described in detail.

As shown in FIG. 9, as an example, the dash panel 25 has the shape of a front portion of the dash panel 22 of the first embodiment described above when the dash panel 22 is divided at substantially the center in the vehicle front-rear direction. That is, the dash panel 25 has, on its rear face in the vehicle front-rear direction, recessed passages 25A that constitute front portions of the main passages 24A and the communication passages 24B in the vehicle front-rear direction. The recessed passages 25A include main recessed passages 25B. Each of the main recessed passages 25B constitutes the main passage 24A and is formed at a position corresponding to the projection 22A.

The plate member 50 is formed of, for example, metal. As an example, the plate member 50 has the shape of a rear portion of the dash panel 22 of the first embodiment described above when the dash panel 22 is divided at substantially the center in the vehicle front-rear direction. That is, the plate member 50 includes, in the vehicle-height direction, six projections 52A projecting in the vehicle front-rear direction, and each of the projections 52A has a flat tip. The plate member 50 also includes recesses 52B recessed in the vehicle front-rear direction between the projections 52A adjacent to each other in the vehicle-height direction. The projections 52A and the recesses 52B extend in the vehicle-width direction. The plate member 50 has, on its front face in the vehicle front-rear direction, recessed passages 50A that constitute rear portions of the main passages 24A and the communication passages 24B in the vehicle front-rear direction. The recessed passages 50A include main recessed passages 50B. Each of the main recessed passages 50B constitutes the main passage 24A and is formed at a position corresponding to the projection 52A.

The dash module 20D is formed by joining the plate member 50 to the dash panel 25 configured as described above from the rear side in the vehicle front-rear direction. The dash panel 25 and the plate member 50 are joined together such that each of the recessed passages 25A of the dash panel 25 faces a corresponding one of the recessed passages 50A of the plate member 50. The recessed passages 25A of the dash panel 25 and the recessed passages 50A of the plate member 50 constitute the internal space 27 serving as the channel.

### Actions and Effects of Third Embodiment

Next, the actions and effects of the third embodiment will be described.

In the vehicle front structure 10B of the third embodiment, the dash panel 25 and the plate member 50 define the internal space 27 serving as the channel. Even when the dash panel 25 and the plate member 50 define the internal space 27 serving as the channel in this manner, effects similar to those of the first embodiment can be obtained.

In addition, in the vehicle front structure 10B of the third embodiment, since the dash panel 25 and the plate member 50 define the internal space 27 serving as the channel at the projections 22A, 52A, the heat generating devices can be cooled by disposing the heat generating devices in contact with or close to the projections 52A of the plate member 50 and the projections 22A of the dash panel 25.

### Fourth Embodiment

Next, a vehicle front structure 10C (refer to FIG. 1) according to a fourth embodiment of the present disclosure will be described. FIG. 10 is a left side sectional view schematically showing an example of a dash module 20E of the vehicle front structure 10C according to the fourth embodiment of the present disclosure. The vehicle front structure 10C of the fourth embodiment includes the dash module 20E shown in FIG. 10. The dash module 20E of the fourth embodiment includes a dash panel 28, and a plate member 60.

Unlike the embodiments described above, the dash panel 28 has no channel. In the present embodiment, an internal space 29 serving as a channel is disposed inside the plate member 60. As an example, the internal space 29 is similar to the internal space 24 of the dash panel 22 of the first embodiment shown in FIG. 3. The plate member 60 has a substantially flat front face attached to the dash panel 28. As an example, a rear face of the plate member 60 has projections 62A and recesses 62B as with the rear face of the dash panel 22 of the first embodiment shown in FIG. 3, and each of the projections 62A has a flat tip face. The dash panel 28 and the plate member 60 are fastened together at their upper end portions in the vehicle-height direction with, for example, a bolt 64.

In the present embodiment, the integrated ECU 34 is mounted on the rear face of the plate member 60. Although not shown, as with the above embodiments, the auxiliary battery 36 is mounted on a front face of the dash panel 28 at a position opposed to the integrated ECU 34 in the vehicle front-rear direction.

### Actions and Effects of Fourth Embodiment

Next, the actions and effects of the fourth embodiment will be described.

In the dash module 20E of the vehicle front structure 10C of the fourth embodiment, the internal space 29 serving as the channel is formed not in the dash panel 28, but in the plate member 60. Thus, the cooling refrigerant flowing thorough the internal space 29 serving as the channel formed in the plate member 60 can cool the heat generating devices.

### Fifth Embodiment

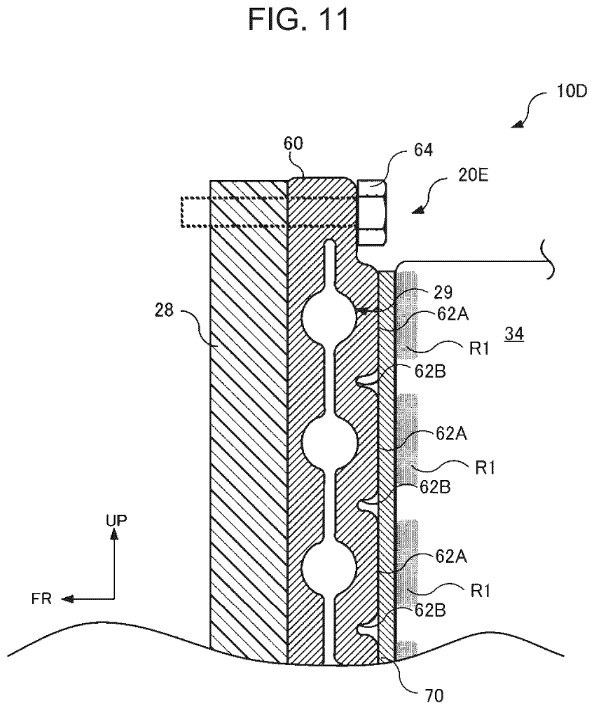

Next, a vehicle front structure 10D according to a fifth embodiment of the present disclosure will be described. FIG. 11 is a left side sectional view schematically showing an example of a main portion including a dash module 20E of the vehicle front structure 10D according to the fifth embodiment of the present disclosure. As an example, the vehicle front structure 10D of the fifth embodiment includes the dash module 20E of the fourth embodiment described above. In the vehicle front structure 10D of the fifth embodiment, for example, the heat generating device such as the integrated ECU 34 is mounted on the dash module 20E with a metal plate 70 or the like interposed therebetween. That is, the integrated ECU 34 is mounted close to the dash module 20E. The metal plate 70 may be, for example, a part of a bracket that is used when the integrated ECU 34 is mounted on the dash module 20E. The dash module 20E may be any one of the dash modules of the first to third embodiments.

### Actions and Effects of Fifth Embodiment

Next, the actions and effects of the fifth embodiment will be described.

In the vehicle front structure 10D of the fifth embodiment, the metal plate 70 is disposed between the dash module 20E and the heat generating device such as the integrated ECU 34. Thus, the heat generating device is mounted not in contact with the dash module 20E but close to the dash module 20E, that is, indirectly mounted on the dash module 20E. Even when the heat generating device is mounted close to the dash module 20E in this manner, the cooling refrigerant fed into the internal space 29 cools the dash module 20E. Thus, the heat generating device can be cooled by the cooled dash module 20E.

### Remarks

Although, in each of the embodiments described above, the vehicle front structure 10, 10A, 10B, 10C, 10D is integrally molded by die casting, the present disclosure is not limited thereto. The vehicle front structure 10, 10A, 10B, 10C, 10D does not have to be formed by die casting.

Although, in each of the embodiments described above, each main passage of the internal space 24, 27, 29 has a substantially circular cross section in side view, the present disclosure is not limited thereto. For example, the main passage may have a substantially rectangular cross section and is not limited to any particular shape as long as the cooling refrigerant can be passed through the main passage.

Although, in each of the embodiments described above, each main passage of the internal space 24, 27, 29 extends in the vehicle-width direction, the present disclosure is not limited thereto. The main passage may extend in the vehicle-height direction. In addition, for example, the internal space 24, 27, 29 may be provided with only main passages, and each main passage may be provided with an inflow port on one end and an outflow port on the other end. Similarly, the refrigerant pipe 26 may extend in the vehicle-height direction. In addition, a plurality of refrigerant pipes 26 may be provided, the refrigerant pipes 26 may be arranged in parallel to each other, and each refrigerant pipe 26 may be provided with an inflow port on one end and an outflow port on the other end.

Although, in each of the embodiments described above, each communication passage of the internal space 24, 27, 29 extends in the vehicle-width direction, the present disclosure is not limited thereto. The shape of the communication passage is not limited to any particular shape as long as the communication passage can provide communication between the main passages adjacent to each other in the vehicle-height direction.

Although, in the vehicle front structure 10A of the second embodiment described above, the refrigerant pipe 26 is disposed in the internal space 23A of the dash panel 23, the present disclosure is not limited thereto. For example, instead of the refrigerant pipe 26, a metal member having a channel inside thereof may be disposed.

Although, in each of the vehicle front structures 10, 10A to 10C of the embodiments described above, at least a part of the channel is disposed facing the heat generating device in the vehicle front-rear direction, the present disclosure is not limited thereto. Even when the channel and the heat generating device are disposed offset from each other in the vehicle front-rear direction, the dash module can cool the heat generating device. At least a part of the channel may be provided on the entire face of the heat generating device. At least a part of the channel may be provided on 50% or more of the area of the face of the heat generating device on the channel side. At least a part of the channel may be provided on 80% or more of the area of the face of the heat generating device on the channel side. At least a part of the channel may be provided on 30% or more of the area of the face of the heat generating device on the channel side. In addition, the “area of the face of the heat generating device on the channel side” may be the sum of the area of the face of the auxiliary battery 36 on the internal space 24 side and the area of the face of the integrated ECU 34 on the internal space 24 side, may be the area of only the face of the auxiliary battery 36, or may be the area of only the face of the integrated ECU 34.

The configuration of the present disclosure is not limited to the above embodiments and can be changed as appropriate as long as the problems can be solved.

What is claimed is:

1. A vehicle front structure comprising:
a dash module that separates an inside and an outside of a vehicle cabin from each other, the dash module having a channel for a cooling refrigerant extending in a vehicle-width direction; and
at least one heat generating device disposed in contact with or close to the dash module.

2. The vehicle front structure according to claim 1, wherein the at least one heat generating device is directly mounted on the dash module.

3. The vehicle front structure according to claim 1, wherein the dash module is mounted on a frame member of a vehicle.

4. The vehicle front structure according to claim 1, wherein:
the dash module includes a dash panel having a plate shape; and
the channel is provided inside the dash panel.

5. The vehicle front structure according to claim 1, wherein:
the dash module includes a dash panel having a plate shape, and a plate member fixed to the dash panel; and
the channel is defined by the plate member and the dash panel.

6. The vehicle front structure according to claim 1, wherein:
the dash module includes a dash panel having a plate shape, and a plate member fixed to the dash panel; and
the channel is provided in the plate member.

7. The vehicle front structure according to claim 1, wherein at least a part of the channel is disposed facing the at least one heat generating device in a vehicle front-rear direction.

8. The vehicle front structure according to claim 7, wherein
the at least one heat generating device includes
a first heat generating device, and
a second heat generating device mounted on the dash module such that the second heat generating device and the first heat generating device face each other with the dash module interposed between the second heat generating device and the first heat generating device.

9. The vehicle front structure according to claim 1, wherein:
the channel extends at least in the vehicle-width direction and comprises a plurality of channels provided in a vehicle-height direction; and
the dash module has a projection projecting in a vehicle front-rear direction in a portion corresponding to each of the channels, the projection having a flat tip face.

10. The vehicle front structure according to claim 1, wherein the channel has an inflow port and an outflow port, the inflow port and the outflow port being provided on one side in the vehicle-width direction.

11. The vehicle front structure according to claim 1, wherein the at least one heat generating device is an auxiliary battery or an integrated control unit.

12. The vehicle front structure according to claim 8, wherein:
the first heat generating device is an auxiliary battery; and
the second heat generating device is an integrated control unit.

13. The vehicle front structure according to claim 5, wherein:
the dash panel is made of resin; and
the plate member is made of metal.
